(19) United States
(12) Patent Application Publication
(10) Pub. No.: US 2008/0265798 A1
(43) Pub. Date: Oct. 30, 2008

(54) Method and System of Controlling a Color Lighting Device

(76) Inventors: Bin-Juine Huang, Taipei (TW); Min-Sheng Wu, Taipei (TW); Yung-Ching Wang, Taipei (TW); Shing-Tung Chen, Taipei (TW); Heng-Lun Tseng, Taipei (TW); Po-Chien Hsu, Taipei (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/108,437

(22) Filed: Apr. 23, 2008

(30) Foreign Application Priority Data
Apr. 26, 2007 (TW) 096114789

(51) Int. Cl. H05B 41/36

(52) U.S. Cl. 315/292

(57) ABSTRACT

A method for adjusting a color lighting device, comprising the following steps: (a) selecting in a user interface to generate a control instruction having various colors with different mixing ratios; (b) transmitting the control instruction to the color lighting device, and storing the control instruction in a memory of the color lighting device; and (c) adjustably emitting color lighting according to the control instruction of step (b). The present invention provides the users the capability of adjusting the color lighting device, thereby furnishing atmosphere of enjoyment to the life of the users.

### CROSS-REFERENCE TO RELATED APPLICATIONS

The present application claims benefit of international priority based on Taiwan application No. 96114789, filed Apr. 26, 2007, by the same assignee.

### BACKGROUND OF THE INVENTION

1. Field of the Invention

The present invention generally relates to method and system of controlling a color lighting device, and more particularly to method and system of controlling a color lighting device through a user interface.

2. Description of the Prior Art

The color of most conventional lighting devices cannot be changed, therefore limiting their applications. A lighting device with specific color can only be custom-made in a factory.

When the required adjustment/scheduling of the lighting devices is not the default setting, users need to wire the lighting devices to a computer and write programs to control color lighting. However, writing the control programs is not user-friendly and can be cumbersome. Also, it may bring inconvenience that way, considering the length, the cost and the volume of the wiring. Accordingly, a common user will have difficulties in adjusting the color lighting. Even when a light adjuster is provided for the user to adjust the color lighting, only one color can be adjusted at a time. The required final color lighting schedule can only be achieved by sequentially adjusting each color through try and error that takes time and patience, and the effects of color changing as a whole can not be evaluated.

### SUMMARY OF THE INVENTION

The abundance of variation in color could influence a person psychologically and be soothing, ultimately changing and improving the physical and mental state of the person. Therefore, an object of the present invention is to provide a method and a system for controlling the color lighting device, creating an atmosphere of enjoyment and soothing to the life.

According to the object, the present invention provides a method for adjusting a color lighting device, comprising the following steps: (a) selecting a control instruction with various colors and different mixing ratios from a user interface; (b) transmitting the control instruction to the color lighting device, and storing the control instruction in a memory of the color lighting device; and (c) the lighting device adjustably emitting color lighting according to the control instruction of step (b).

According to another embodiment, the present invention provides a system of controlling a color lighting device, comprising a controller and at least one color lighting device.

The controller includes a user interface for selecting therein to generate a control instruction with various colors and different mixing ratios; a display module for previewing resultant color lighting according to the control instruction; a storage module for storing the control instruction; and a first transmission module for transmitting the control instruction.

The color lighting device is controlled by the controller to adjust its color lighting. The device includes a lamp whose color emission is adjustable by control; a second transmission module for receiving the control instruction; a memory for storing the control instruction; and a driver module, which adjusts color lighting of the lamp according to the control instruction.

The method and system of controlling a color lighting device according to the present invention provides the user the capability of selecting various colors with different mixing ratios to adjust the color lighting device, thereby enhancing the applicability of the color lighting device.

### BRIEF DESCRIPTION OF THE DRAWINGS

FIG. 1 illustrates a system of controlling a color lighting device according to a preferred embodiment of the present invention; and

FIG. 2 shows a flowchart illustrating a method for adjusting color lighting according to a preferred embodiment of the present invention.

### DETAILED DESCRIPTION OF THE INVENTION

These and other features, aspects, and advantages of the present invention will become better understood with regard to the following description, preferred embodiments and accompanying drawings.

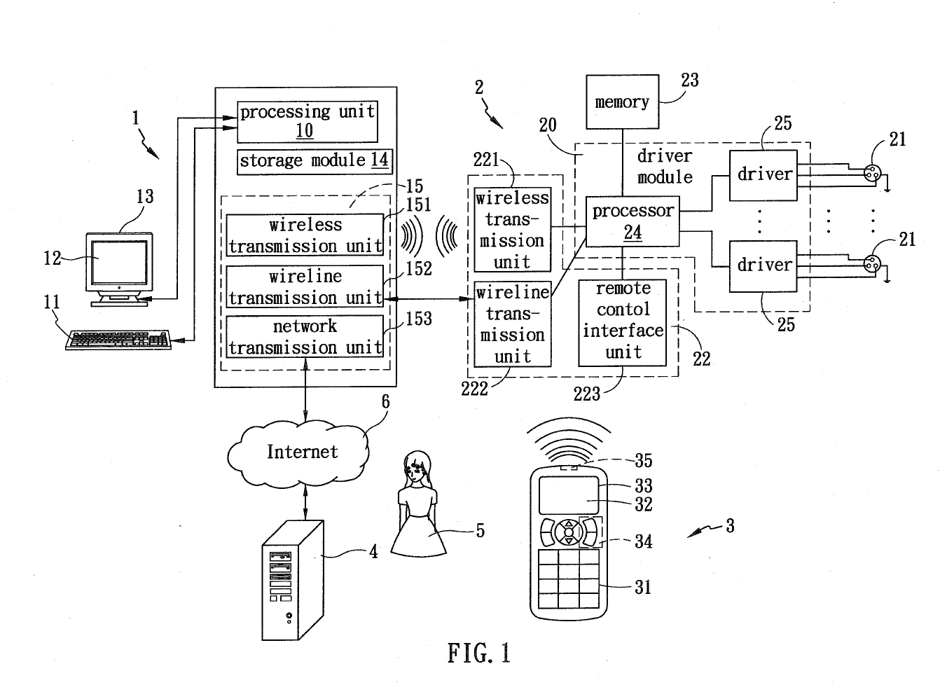

FIG. 1 illustrates a system of controlling a color lighting device according to a preferred embodiment of the present invention, which includes a controller 1, a color lighting device 2, a remote controller 3, and a management server 4.

The controller 1 may be a computer, or other electronic devices capable of surfing the Internet or a personal computer by a user 5. In the embodiment, the controller 1 includes a processing unit 10, an input module 11, a user interface 12, a display module 13, a storage module 14, and a first transmission module 15. The processing unit 10 is configured to control and coordinate the operation among elements. The input module 11 provides input means, such as keyboard or/and mouse for the user 5. The first transmission module 15 includes a wireless transmission unit 151 (for example, a wireless communication interface such as infra red or Bluetooth) for transmitting data to/from the color lighting device 2, a wireline transmission unit 152 (for example, serial communication technique such as RS232, RS485, or USB) for connecting with the color lighting device 2, and a network transmission unit 153 (for example, network interface card (NIC)) for connecting to the Internet 6 or a personal computer.

In the embodiment, one or both of the following two ways could be utilized to adjust color lighting. In the first way, the user 5 downloads data via the Internet (or World Wide Web) 6 or a personal computer; and in the second way, customized color is made via the user interface 12.

With respect to downloading via the Internet 6 or a personal computer, a web page is retrieved from the management server 4 via the Internet 6, and is then displayed in the controller 1 of the user 5. The user 5 may download to retrieve a control instruction on the web page that is associated with a pre-adjusted color; or alternatively the user 5 may adjust to acquire the needed color and associated generated control instruction by using the functions provided on the web page. In either way, the retrieved or generated control instruction is forwarded to be stored in the storage module 14 of the controller 1.

The user interface 12 that is displayed on the display module 13 may provide various primary colors (for example, the three primary colors) and mixed colors based on the primary colors. The user 5 may adjust the intensity and the proportion/ratio of the various colors, and then preview the adjusted mixed color on the spot. The user interface 12, alternatively, may provide a palette with various mixed colors (for example, the red/green/blue primary colors and mixed colors thereof) with different ratios and associated control instructions. The user 5 may intuitively choose different colors from the palette, and therefore generate corresponding control instructions. Upon the selection, the user 5 may preview the result on the display module 13, and then store the result in the storage module 14.

Further, the user interface 12 may provide the user 5 the capability to schedule the color change through timeframe so that colors with different mixing ratio may change corresponding to different points in the timeframe. The resultant schedule is previewable, and may be stored in the storage module 14. As the adjustment and the scheduling are finished, the color lighting device 2 are prepared to subsequently update its adjustment/scheduling control instructions.

The color lighting device 2 adjusts color lighting under the control of the controller 1. In the embodiment, the color lighting device 2 includes a driver module 20, various color lamps 21, a second transmission module 22, and a memory 23. The memory 23 is, for example, a rewritable memory device that stores an adjustment/scheduling control instruction preset during the manufacturing. The second transmission module 22 includes a wireless transmission unit 221 for transmitting data to/from the controller 1, a wireline transmission unit 222, and a remote control interface unit 223 for receiving signals from a remote controller 3. Each lamp 21 includes several controllable light-emitting diodes (LEDs) that have various colors (such as the primary red/green/blue colors or other colors). The driver module 20 includes a processor, such as a microprocessor 24, and various pairs of drivers 25 associating with the various color lamps 21.

In the lighting operation of the color lamps 21, the microprocessor 24 outputs voltage/current control signals to the drivers 25 according to the adjustment/scheduling control instructions stored in the memory 23. The constituents such as bipolar junction transistor (BJT) or field effect transistor (FET) of the drivers 25 amplify the voltage/current control signals of the microprocessor 24, and output various powers to respectively drive the color lamps 21, thereby generating various colors.

For example, the user 5 operates the user interface 12 (for example, selects a transmission button) to update the adjustment/scheduling control instructions in the memory 23 by transmitting control instructions to the microprocessor 24 in wireless manner (for example, from the wireless transmission unit 151 to the wireless transmission unit 221) or in wireline manner (for example, from the wireline transmission unit 152 to the wireline transmission unit 222). Upon the reception, the microprocessor 24 updates the adjustment/scheduling control instructions in the memory 23, followed by outputting voltage/current control signals to the drivers 25 according to the updated control instructions, thereby generating various colors or/and lighting scheduling.

Alternatively, the lighting operation of the color lamps 21 may be performed by firstly transmitting a pre-stored instruction of the color lamp 21 to the controller 1 either in wireless manner (for example, from the wireless transmission unit 221 to the wireless transmission unit 151) or in wireline manner (for example, from the wireline transmission unit 222 to the wireline transmission unit 152). The mixing ration of the pre-stored instruction then may be edited or adjusted via the user interface 12 of the controller 1. The edited/adjusted instruction is subsequently transmitted back to the lighting device 2, whose memory 23 is then updated.

Alternatively, the remote controller 3 may be used instead of the controller 1 to adjust the color lighting. The remote controller 3 includes a processing unit (not shown), an input module 31, a user interface 32, a display module 33, a storage module 34, and a remote control transmission module 35.

A program is embedded in the processing unit to provide various operating modes. The user 5, for example, may intuitively adjust the mixing ratio of various colors (such as the red/green/blue primary colors) via the user interface 32, and therefore generate corresponding control instructions. Upon the selection via the input module 31, the user 5 may concurrently observe the color lighting of the color lamps 21; or may preview the result on the display module 33, and store the result in the storage module 34. Further, the user interface 32 may provide the user 5 the capability to schedule the color change through timeframe, and the resultant schedule may be stored in the storage module 34.

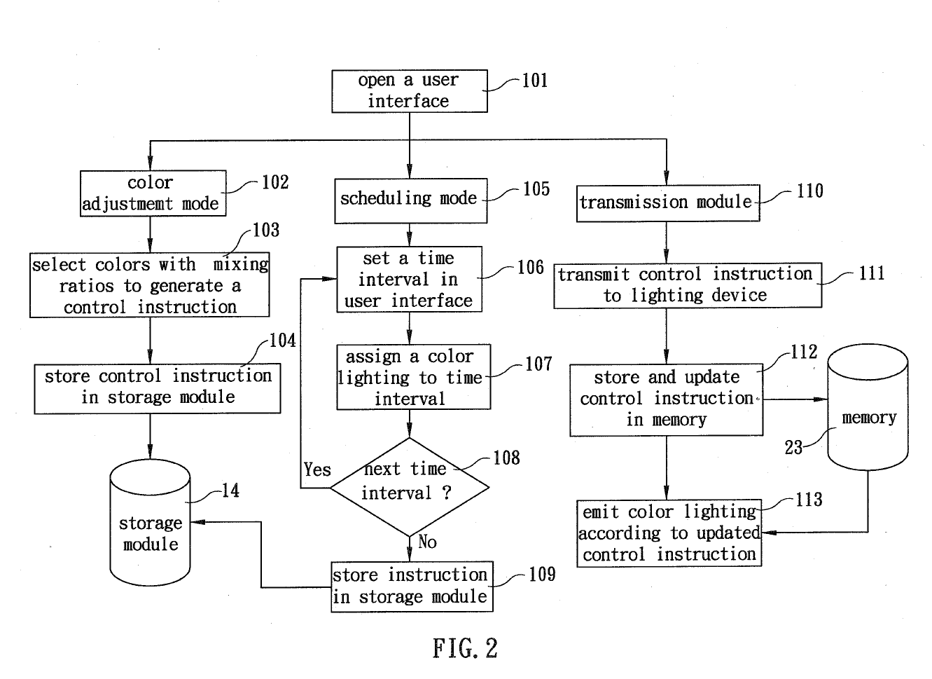

FIG. 2 shows a flowchart illustrating a method for adjusting color lighting according to a preferred embodiment of the present invention. A user interface 12 is firstly opened (step 101). In the embodiment, the user interface 12 provides three operating modes: color adjustment mode (step 102), a scheduling mode (step 105), and a transmission mode (step 110).

In the color adjustment mode (step 102), the user 5 may select a preset color and generate a corresponding control instruction (step 103) in the user interface 12. The result associated with the control instruction may be previewable, and then stored in the storage module 14 (step 104).

In the scheduling mode (step 105), the user 5 may set a time interval in the user interface 12 (step 106) and assign a color lighting to that time interval (step 107). If there is still another time interval to be set and assigned (the yes branch of step 108), the steps 106 and 107 are repeatedly performed; otherwise (the no branch of step 108), the resultant schedule is previewable, and the schedule-associated instruction is stored in the storage module 14 (step 109).

In the transmission mode (step 110), the control instructions discussed above are transmitted to the color lighting device 2 (step 111), followed by storing and updating the control instruction in the memory 23 of the color lighting device 2 (step 112). Subsequently, the color lighting device 2 emits color lighting according to the updated control instruction (step 113). Further, with respect to one aspect of the present invention, the color lighting device 2 may transmit a pre-stored instruction to the controller 1.

The method and system of controlling color lighting device according to the present invention have following advantages:
1. a user 5 could simply select needed colors in the user-friendly user interface 12/32 to acquire the resultant color lighting without tiresome programming;
2. the controller 1 or remote controller 3 may transmit control instruction to the color lighting device 2 conveniently in wireless manner instead of complex wiring; and
3. the substantial reduction in operating time could enhance the applicability of the color lighting to provide atmosphere of enjoyment to the life of the user 5.

Although specific embodiments have been illustrated and described, it will be appreciated by those skilled in the art that various modifications may be made without departing from the scope of the present invention, which is intended to be limited solely by the appended claims.

What is claimed is:

1. A method for adjusting a color lighting device, comprising the following steps:
(a) selecting in a user interface to generate a control instruction with various colors and different mixing ratios;
(b) transmitting the control instruction to the color lighting device, and storing the control instruction in a memory of the color lighting device; and
(c) adjustably emitting color lighting according to the control instruction of step (b).

2. The method of claim 1, wherein the control instruction in step (b) is downloaded from Internet.

3. The method of claim 1, wherein the control instruction in step (b) is transmitted in wireless manner.

4. The method of claim 1, wherein the step (b) further comprises a step:
(b1) updating a control instruction pre-stored in the memory.

5. A method for adjusting a color lighting device, comprising the following steps:
(a) editing in a user interface to generate a control instruction in which different colors respectively correspond to different points in a timeframe;
(b) transmitting the control instruction to the color lighting device, and storing the control instruction in a memory of the color lighting device; and
(c) adjustably emitting color lighting through the timeframe according to the control instruction of step (b).

6. The method of claim 5, wherein the control instruction in step (b) is downloaded from Internet.

7. The method of claim 5, wherein the control instruction in step (b) is transmitted in wireless manner.

8. The method of claim 5, wherein the step (b) further comprises a step:
(b1) updating a control instruction pre-stored in the memory.

9. A system of controlling a color lighting device, comprising:
a controller including:
a user interface for selecting therein to generate a control instruction having various colors with different mixing ratios;
a display module for previewing resultant color lighting according to the control instruction;
a storage module for storing the control instruction;
a first transmission module for transmitting the control instruction; and
at least a color lighting device, whose color lighting is adjustable by the controller, the color lighting device including:
a lamp whose color lighting is controllably adjustable;
a second transmission module for receiving the control instruction;
a memory for storing the control instruction; and
a driver module, which adjusts color lighting of the lamp according to the control instruction.

10. The system of claim 9, wherein the lamp comprises light-emitting diodes having three primary colors respectively.

11. The system of claim 9, wherein the first transmission module comprises a wireless transmission module for transmitting the control instruction to or from the color lighting device in wireless manner.

12. The system of claim 9, wherein the user interface displays a web page providing color lighting selection.

13. The system of claim 9, wherein the control instruction has various colors with different mixing ratios.

14. The system of claim 9, wherein the driver module comprises a processor and a driver, the processor outputting a control signal to the driver that generates various powers to drive the lamp, thereby generating various colors.

15. A system of controlling a color lighting device, comprising:
a controller including:
a user interface for editing therein to generate a control instruction in which different colors respectively correspond to different points in a timeframe;
a display module for previewing resultant color lighting according to the control instruction;
a storage module for storing the control instruction;
a first transmission module for transmitting the control instruction; and
at least a color lighting device, adjustably emitting color lighting through the timeframe according to the control instruction, the color lighting device including:
a lamp whose color lighting is controllably adjustable;
a second transmission module for receiving the control instruction;
a memory for storing the control instruction; and
a driver module, which adjusts color lighting of the lamp through the timeframe according to the control instruction.

16. The system of claim 15, wherein the lamp comprises light-emitting diodes having three primary colors respectively.

17. The system of claim 15, wherein the first transmission module comprises a wireless transmission module for transmitting the control instruction to or from the color lighting device in wireless manner.

18. The system of claim 15, wherein the user interface displays a web page providing color lighting selection.

19. The system of claim 15, wherein the control instruction has various colors with different mixing ratios.

20. The system of claim 15, wherein the driver module comprises a processor and a driver, the processor outputting a control signal to the driver that generates various powers to drive the lamp, thereby adjusting color lighting of the lamp through the timeframe.

21. A method for adjusting a color lighting device, comprising the following steps:
(a) transmitting a pre-stored instruction from the color lighting device;
(b) editing the pre-stored instruction in a user interface to generate a control instruction having various colors with different mixing ratios; and
(c) adjustably emitting color lighting according to the control instruction of step (b).
